(19) United States
(12) Patent Application Publication
(10) Pub. No.: US 2007/0195241 A1
(43) Pub. Date: Aug. 23, 2007

(54) Display panel having substrate with improved aperture ratio

(75) Inventor: Ji-Suk Lim, Daejeon (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/706,714

(22) Filed: Feb. 14, 2007

(30) Foreign Application Priority Data
Feb. 17, 2006 (KR) 2006-15465

(51) Int. Cl. G02F 1/1335

(52) U.S. Cl. 349/114

(57) ABSTRACT

A display panel includes a plurality of source wirings, gate wirings, pixel areas and pixel electrodes. The source wirings are extended in a first direction, and the gate wirings are extended in a second direction crossing the first direction. The pixel areas are defined by the source wirings and the gate wirings. Each of the pixel electrodes is formed in each of the pixel areas and includes a first reflection electrode and a second reflection electrode formed at both ends of the pixel areas and defining a first reflection area and a second reflection area, and a transparent electrode formed between the first and second reflection electrodes and defining a transmission area. The pixel area is arranged in the first reflection area, the transmission area and the second reflection area. The aperture ratio is not decreased because light does not leak at the boundary between the transmission and reflection area.

### CROSS-REFERENCE TO RELATED APPLICATIONS

This application relies for priority upon Korean Patent Application No. 2006-0015465 filed on Feb. 17, 2006, the contents of which are herein incorporated by reference.

### FIELD OF THE INVENTION

The present invention relates to a display panel formed of a substrate having an improved aperture ratio together with its method of manufacture.

### DESCRIPTION OF THE RELATED ART

In general, a transreflective LCD apparatus uses both reflected and transmitted light and provides a high quality image with low power consumption using different gamma curves for each mode. The display panel is divided into a reflection area having a reflection electrode and a transmission area having a transmission electrode. The reflection area and the transmission area are defined by a lower organic layer. The lower organic layer is formed on the reflection area but not on the transmission area thereby forming a stepped portion of the organic layer at the boundary between the reflection and transmission areas where the liquid crystal is not uniformly controlled so that leakage of light occurs. In addition, the aperture ratio is decreased.

### SUMMARY OF THE INVENTION

The present invention provides a display substrate having an improved aperture ratio in which each pixel includes a first reflection electrode, a second reflection electrode and a transparent electrode and in which light leakage is avoided in the boundary between the transmission and reflection areas. The first and second reflection electrodes are formed at the ends of the pixel and define a first and a second reflection area. The transparent electrode is formed between the first and second reflection electrodes and defines the transmission area.

Each of the plurality of pixels includes a first switching device electrically connected to the Mth source wiring and the (N−1)th gate wiring, a first pixel electrode electrically connected to the first switching device, a second switching device connected to the Mth source wiring and the Nth gate wiring, and a second pixel electrode electrically connected to the second switching device, where M and N are natural numbers. The first switching device is formed in the first reflection area, and the second switching device is formed in the second reflection area. First and second storage electrodes are formed adjacent to the first and second switching devices.

When an organic insulation layer is formed in the first and second reflection area, a first stepped portion is formed on the boundary between the transmission area and the first reflection area, and a second stepped portion is formed on the boundary between the transmission area and the second reflection area. The first reflection electrode is extended to cover the first stepped portion, and the second reflection electrode is extended to cover the second stepped portion.

A method of manufacturing the display panel includes forming a switching device in a pixel area, forming an organic insulation layer on the pixel area that includes the switching device, forming a first organic insulation pattern and a second organic insulation pattern at end portions of the pixel area to divide the pixel area into a first reflection area, a transmission area and a second reflection area, forming a transparent electrode electrically connected to the switching device in the transmission area, and forming a first reflection electrode and a second reflection electrode on the first and second organic insulation pattern.

### BRIEF DESCRIPTION OF THE DRAWINGS

The above and other objects, advantages and features of the present invention will become more apparent from a reading of the ensuing description together with the drawing, in which:

FIG. 1 is a plan view illustrating a transreflective display substrate in accordance with a first embodiment of the present invention;

FIGS. 2 and 3 are cross-sectional views taken along the line I-I′ of FIG. 1;

FIG. 4 is a cross-sectional view illustrating a display panel having the display substrate of FIG. 1; and

FIG. 5 is a cross-sectional view illustrating a transreflective display substrate in accordance with a second embodiment of the present invention.

### DESCRIPTION OF THE EMBODIMENTS

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

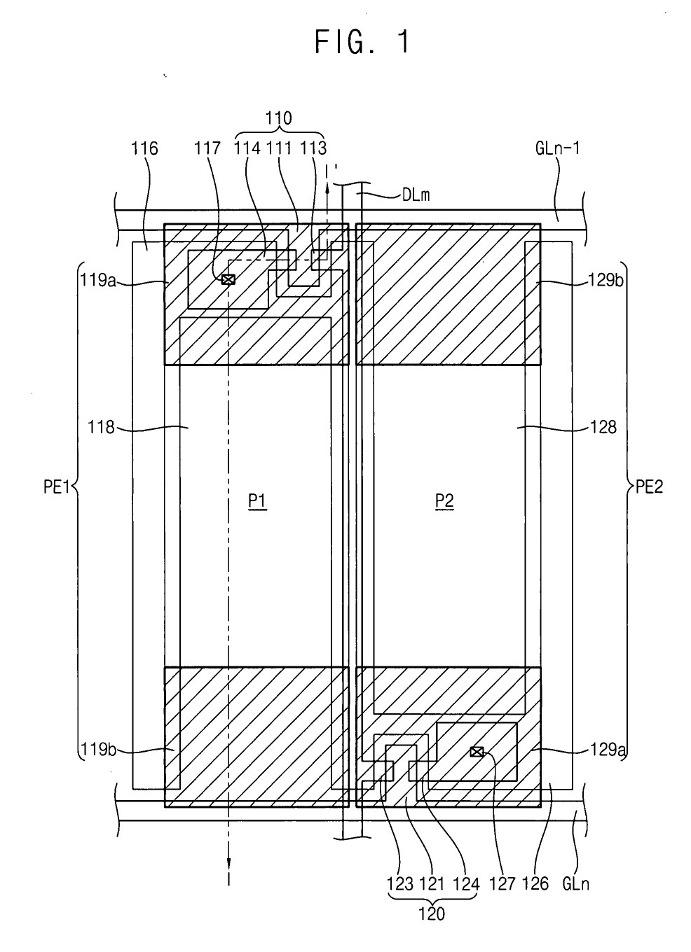

Referring to FIG. 1, the transreflective display substrate has a pixel structure with fewer source wirings. The display substrate includes M/2 source wirings DLm extending in a first direction, N gate wirings GLn extending in a second direction crossing the first direction and L pixel areas defined by the intersection of the source wirings and the gate wirings. The number L is equal to the number M times the number N.

For example, first and second pixel areas P1 and P2 that are adjacent to each other along the first direction may be defined by the intersection of the (N−1)th and Nth gate wirings GLn−1 and GLn with the Mth source wiring DLm.

The first pixel area P1 includes a first switching device 110, a first storage electrode 116 and a first pixel electrode PE1. The first pixel electrode PE1 includes a transparent electrode 118, a first reflection electrode 119a and a second reflection electrode 119b.

The first switching device 110 includes a first gate electrode 111 extended from the (N−1)th gate wiring GLn−1, a source electrode 113 extended from the Mth source wiring DLm and a drain electrode 114 electrically connected to the first transparent electrode 118 through a first contact hole 117. The first storage electrode 116 is formed in the first pixel area P1, and a first storage capacitor is defined by the first storage electrode 116 and the first pixel electrode PE1.

The first transparent electrode 118 of the first pixel electrode PE1 is formed at a central area of the first pixel area P1. The first reflection electrode 119a is formed at a first end portion area of the first pixel area P1 having the first switching device 110, and the second reflection electrode 119b is formed at a second end portion area of the first pixel area P1. The second end portion area of the first pixel area P1 is opposite to the first end portion area of the first pixel area P1 facing the first reflection electrode 119a. The first pixel area P1 is divided into a transmission area TA, first and second reflection areas RA1 and RA2 formed at opposite sides of the transmission area TA.

The second pixel area P2 includes a second switching device 120, a second storage electrode 126 and a second pixel electrode PE2. The second pixel electrode PE2 includes a second transparent electrode 128, a third reflection electrode 129A and a forth reflection electrode 129B.

The second switching device 120 includes a second gate electrode 121 extended from the Nth gate wiring GLn, a source electrode 123 extended from the Mth source wiring DLm and a drain electrode 124 electrically connected to the second transparent electrode 128 through a second contact hole 127. The second storage electrode 126 is formed in the second pixel area P2, and a second storage capacitor is defined by the second storage electrode 126 and the second pixel electrode PE2.

The second transparent electrode 128 of the second pixel electrode PE2 is formed at a central area of the second pixel area P2. In addition, the third reflection electrode 129a is formed at a first end portion of the second pixel area P2 having the second switching device 120, and the forth reflection electrode 129b is formed at a second end portion of the second pixel area P2. The second end portion of the second pixel area P2 is opposite to the first end portion of the second pixel area P2 facing the second reflection electrode 129a. Thereby, the second pixel area P2 is divided into a transmission area TA, and third and forth reflection area RA1 and RA2 formed at both opposite sides of the transmission area TA.

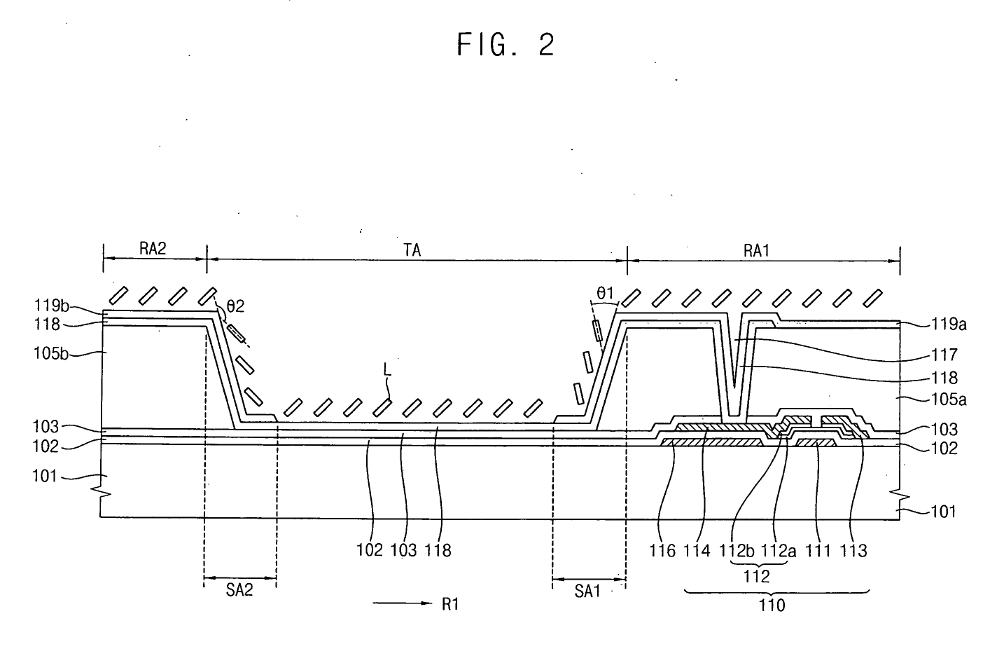

Referring to FIGS. 1 and 2, the display substrate includes a base substrate 101. A gate metallic pattern is formed on the base substrate 101 as a gate metallic layer. The gate metallic pattern includes the Nth gate wiring GLn−1, the first gate electrode 111 and the first storage electrode 116. The first gate electrode 111 and the first storage electrode 116 are extended from the (N−1)th gate wiring GLn−1.

A gate insulation layer 102 is formed on the base substrate 101 and the gate metallic pattern. A semiconductor layer 112 is formed on gate insulation layer 102 corresponding to the gate electrode 116. Semiconductor layer 112 includes an active layer 112a having an amorphous silicon layer and an ohmic contact layer 112b of amorphous silicon implanted with a high concentration of impurities.

A protective insulation layer 103 is formed on base substrate 101 and semiconductor layer 112. A source metallic pattern is formed on base substrate 101 including the protective insulation layer 103 as a source metallic layer. The source metallic pattern includes the Mth source wiring DLm, the first source electrode 113 extended from the Mth source wiring DLm and the first drain electrode 114 overlapped by first storage electrode 116.

An organic insulation layer is formed on base substrate 101 and the source metallic pattern. The organic insulation layer is patterned so that the organic insulation layer corresponding to the transmission area TA is removed while the organic insulation layer corresponding to the first and second reflection areas RA1 and RA2 remains. Therefore, a first organic insulation pattern 105a is formed on the first reflection area RA1, and a second organic insulation pattern 105b is formed on the second reflection area RA2.

The first and second organic insulation patterns 105a and 105b are formed in the first and second reflection areas RA1 and RA2, respectively, so that the cell gaps of the transmission area TA and the reflection areas RA1 and RA2 are different from each other. Some incident light passes through transmission area TA while light is reflected from the first and second reflection areas RA1 and RA2; thus, the light paths are different. The first and second organic insulation patterns 105a and 105b are formed in the first and second reflection areas RA1 and RA2, respectively. Thus, the first and second organic insulation patterns 105a and 105b adjust the light paths of the transmission area TA and the first and second reflection areas RA1 and RA2 so that the light paths are substantially the same in the transmission area TA and the first and second reflection areas RA1 and RA2.

The first organic insulation pattern 105a and the protective insulation layer 103 corresponding to an area of the first reflection area RA1 are partially removed to form the first contact hole 117 partially exposing the first drain electrode 114.

A transparent conductive material layer is deposited on base substrate 101 including the first contact hole 117 to cover the first and second organic insulation patterns 105a and 105b, and the transparent conductive material layer is patterned to form the first transparent electrode 118. Examples of a transparent conductive material that can be used for the first transparent electrode 118 include Indium Tin Oxide (ITO), Tin Oxide (TO), or Indium Zinc Oxide (IZO). These can be used alone or in a combination thereof.

A reflective electrode layer is deposited on the first transparent electrode 118 and is patterned to form the first reflection electrode 119a corresponding to the first reflection area RA1, and the second reflection electrode 119b corresponding to the second reflection area RA2. In FIGS. 1 and 2, the first and second reflection electrodes 119a and 119b are formed on the first transparent electrode 118. Alternatively, the first and second reflection electrodes 119a and 119b electrically connected to each other may be formed on the transmission area TA and the first and second reflection areas RA1 and RA2, respectively.

The first reflection electrode 119a is extended to a portion of the transmission area TA. The first reflection electrode 119a is extended to cover a first stepped portion SA1 that is formed by the first organic insulation pattern 105a. The leakage of light caused by an abnormal arrangement of liquid crystal molecules L is blocked by the extended portion of the first reflection electrode 119a that is extended toward the first stepped portion SA1.

The second reflection electrode 119b is extended to a portion of the transmission area TA. The second reflection electrode 119b is extended to cover a second stepped portion SA2 that is formed by the second organic insulation pattern 105b. The leakage of the first light caused by an abnormal arrangement of the liquid crystal molecules L is blocked by the extended portion of the second reflection electrode 119b that is extended toward the second stepped portion SA2.

For example, as shown in FIG. 2, when the liquid crystal molecules L are aligned in a first rubbing direction R1, the liquid crystal molecules L are arranged abnormally on the first stepped portion SA1 and the second stepped portion SA2. The liquid crystal molecules L on the first stepped portion SA1 are arranged at an inclined angle of less than about 90 degrees (0°<θ1<90°). Thus, when electric field is applied to the liquid crystal molecules L on the first stepped portion SA1, the arrangement angle of the liquid crystal molecules L on the first stepped portion SA1 is easily adjusted. Therefore, light may not leak on the first stepped portion SA1.

On the other hand, the liquid crystal molecules L on the second stepped portion SA2 are arranged at an inclined angle of more than about 90 degrees (90°<θ2<180°). Thus, when the electric field is applied to the liquid crystal molecules L on the second stepped portion SA2, the angle of the liquid crystal molecules L on the second stepped portion SA2 is not easily adjusted. Therefore, light may leak on the second stepped portion SA2. In order to prevent light from leaking on the second stepped portion SA2, the second reflection electrode 119b is extended to the second stepped portion SA2, thereby blocking the light on the second stepped portion SA2. Therefore, each pixel area P1 is divided into the first reflection area RA1, the transmission area TA and the second reflection area RA2 so that light from leaking in a first rubbing direction R1 is prevented.

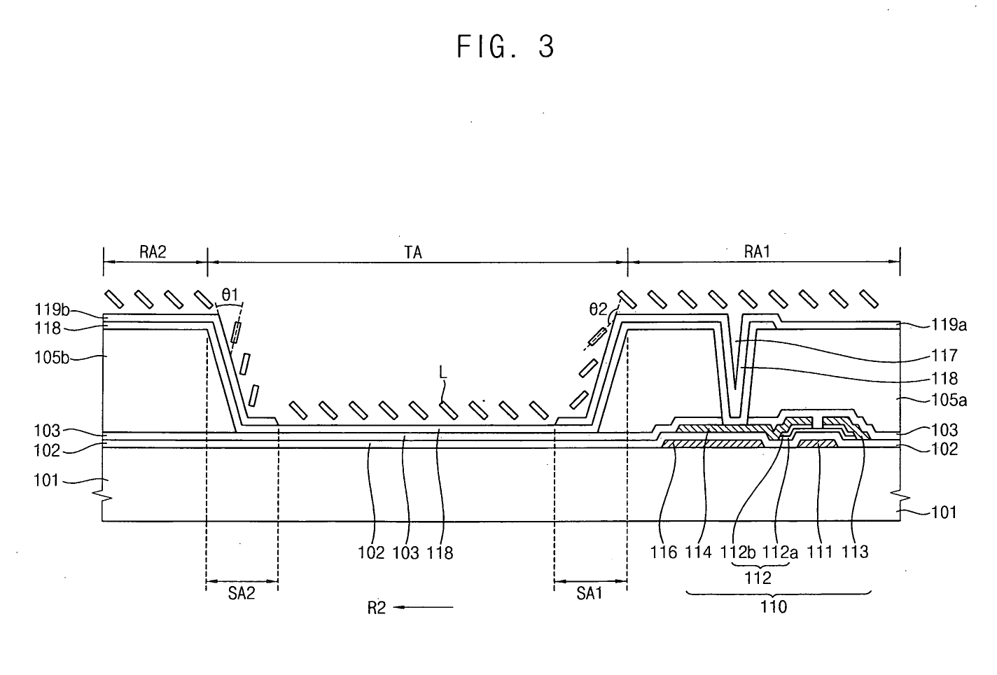

FIG. 3 is also cross-sectional views taken along the line I-I′ of FIG. 1, same as shown in FIG. 2. The first rubbing direction R1 of FIG. 2 is opposite to the second rubbing direction R2 of FIG. 3.

Referring to FIG. 3, when liquid crystal molecules L are aligned in the second rubbing direction R2, the liquid crystal molecules L are arranged abnormally on the first stepped portion SA1 and the second stepped portion SA2. The liquid crystal molecules L on the first stepped portion SA1 are arranged at an inclined angle more than about 90 degrees (90°<θ1<180°). Thus, when electric field is applied to the liquid crystal molecules L on the first stepped portion SA1, the angle of the liquid crystal molecules L on the first stepped portion SA1 is not easily adjusted. Therefore, light may leak on the first stepped portion SA1. In order to prevent the light from leaking on the first stepped portion SA1, the first reflection electrode 119a in the first reflection area RA1 is extended to the first stepped portion SA1.

On the other hand, the liquid crystal molecules L on the second stepped portion SA2 are arranged at an inclined angle less than about 90 degrees (0°<θ2<90°). Thus, when the electric field is applied to the liquid crystal molecules L on the second stepped portion SA2, the angle of the liquid crystal molecules L on the second stepped portion SA2 is easily adjusted. Therefore, light may not leak on the second stepped portion SA2, and is easier to control than on the first stepped portion SA1.

Therefore, each pixel area P1 is divided into the first reflection area RA1, the transmission area TA and the second reflection area RA2 so that the light leaking in the second rubbing direction R2 is prevented.

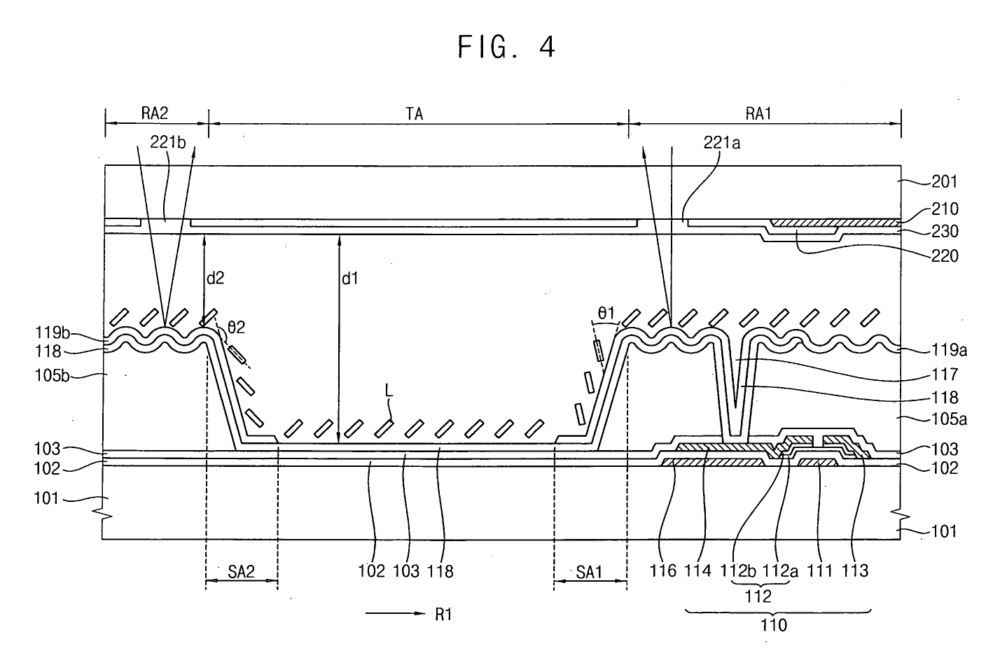

FIG. 4 is a cross-sectional view illustrating a display panel having the display substrate of FIG. 1. Referring to FIGS. 1 and 4, a display panel includes an array substrate 100, an opposite substrate 20 and a liquid crystal layer 300.

The array substrate 100 includes M/2 source wirings extended along a first direction, N gate wirings extended along a second direction crossing the first direction and L pixel areas defined by the source wirings and the gate wirings. The number L is equal to the number M times the number N. For example, first and second pixel areas P1 and P2 that are adjacent to each other along the first direction are defined by (N−1)th and Nth gate wirings GLn−1 and GLn and an Mth source wiring DLm. Each of the first and second pixel areas P1 and P2 is divided into a transmission area TA, and the first and second reflection areas RA1 and RA2 are disposed on each end portion of the transmission area TA. First and second organic insulation patterns 105a and 105b are formed in the first and second reflection areas RA1 and RA2, respectively. Surfaces of the first and second organic insulation patterns 105a and 105b may have concave and convex patterns, thereby improving a reflectivity.

First and second reflection electrodes 119a and 119b formed in the first and second reflection areas RA1 and RA2, respectively, are extended to first and second stepped portions SA1 and SA2 of the transmission area TA. Thereby, a leakage of light caused by an abnormal arrangement of liquid crystal molecules L is decreased in the first and second stepped portions SA1 and SA2.

The opposite substrate 200 includes a base substrate 201. A light blocking layer 210, a color filter layer 220 and a common electrode layer 230 are formed on the base substrate 201.

The light blocking layer 210 defines an inner space corresponding to each pixel area. The color filter layer 220 is formed in the inner space. The color filter layer 220 corresponding to the first and second reflection areas RA1 and RA2 are partially removed to form the first and second light holes 221A and 221B. The light holes 221A and 221B improve a luminance of second light L2 that is reflected from the first and second reflection electrodes 119a and 119b.

Color filter layer 220 corresponding to the first and second reflection areas RA1 and RA2 has a first thickness T1, and color filter layer 220 corresponding to the transmission area TA has a second thickness T2. The second thickness T2 is greater than the first thickness T1, and the color filter layer 220 in the transmission area TA has a higher color purity than the color filter layer 220 in the first and second reflection areas RA1 and RA2. The second light L2 corresponding to the first and second reflection areas RA1 and RA2 passes through the color filter layer 220 twice, but the first light L1 having passed through the transmission area TA passes through the color filter layer 220 once. Therefore, the color filter layer 220 of the transmission area TA has a greater thickness than the first and second reflection areas RA1 and RA2. Thus, color reproducibility of the transmission area TA may be substantially the same as the first and second reflection areas RA1 and RA2.

Common electrode layer 230 is formed on color filter layer 220 and faces the first and second pixel electrodes PE1 and PE2 of array substrate 100.

Liquid crystal layer 300 is disposed between array substrate 100 and the opposite substrate 200. The liquid crystal layer 300 has different cell gaps corresponding to the transmission area TA and the first and second reflection areas RA1 and RA2. Light L1 passing through the transmission area TA has a different light path from the second light L2 which is reflected from the first and second reflection areas RA1 and RA2 so that a first cell gap D1 of the transmission area TA and a second cell gap D2 of the first and second reflection areas RA1 and RA2 are different from each other. For example, the first cell gap D1 is about twice as the second cell gap D2.

The liquid crystal molecules L of the liquid crystal layer 300 are aligned in a first rubbing direction R1. The liquid crystal molecules L of the liquid crystal layer 300 are arranged abnormally on the first and second stepped portions SA1 and SA2 corresponding to a boundary portion between the transmission area TA and the first and second reflection areas RA1 and RA2. However, in FIG. 4, the first and second reflection electrodes 119a and 119b are extended to the first and second stepped portions SA1, SA2 to prevent light from leaking on the first and second stepped portions SA1 and SA2.

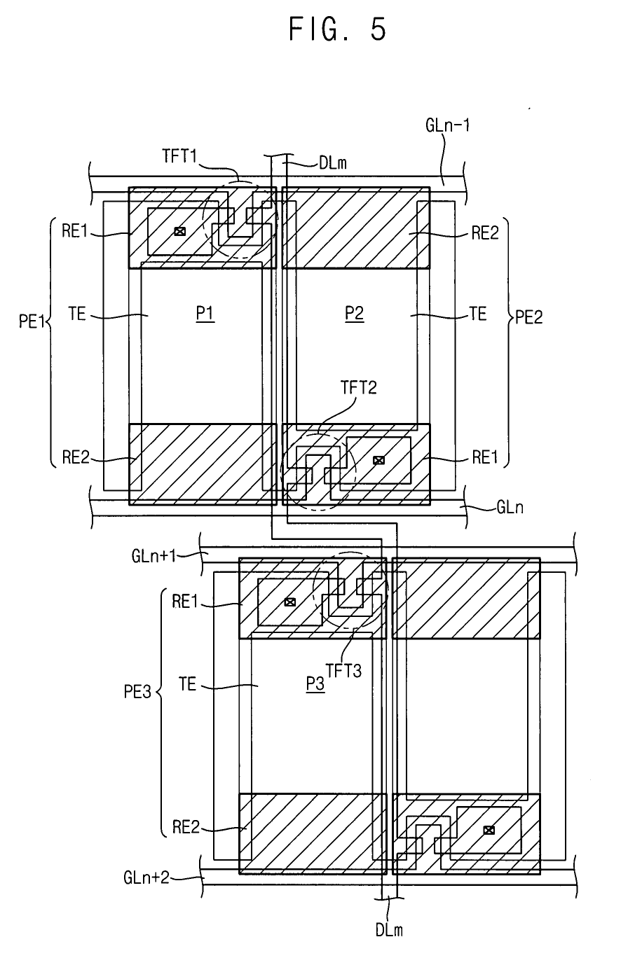

FIG. 5 is a cross-sectional view illustrating a transreflective display substrate in accordance with a second embodiment of the present invention.

Referring to FIG. 5, the display substrate includes M/2 source wirings extended along a first direction, N gate wirings extended along a second direction crossing the first direction and L pixel areas defined by the source wirings and the gate wirings. The number L is equal to the number M times the number N.

For example, first and second pixel areas P1 and P2 that are adjacent to each other along the first direction are defined by (N−1)th and Nth gate wirings GLn−1 and GLn and an Mth source wiring DLm. Third and forth pixel areas P3 and P4 that are adjacent to the first and second pixel areas P1 and P2 along a second direction, respectively, are defined by (n+1)-th and (n+2)-th gate wirings GLn+1 and GLn+2 and the Mth source wiring DLm. The third pixel area P3 is disposed between the first and second pixel P1 and P2. The first and second and third pixel areas P1, P2 and P3 are arranged in a delta shape (A).

The first pixel area P1 has a relatively higher charge rate from a data signal than the second pixel area P2, and the third pixel area P3 has a relatively higher charge rate from a data signal than the forth pixel area P4. Thereby, when the pixel areas P1, P2, P3 and P4 are arranged in the delta shape, horizontal lines caused by the difference between the charge rates of the pixel areas P1, P2, P3 and P4 are displayed on a display panel.

The first pixel area P1 includes a first switching device TFT1 electrically connected to the (N−1)th gate wiring GLn−1 and the Mth source wiring DLm, and a pixel electrode PE1 electrically connected to the first switching device TFT1. The first pixel electrode PE1 includes a transparent electrode TE, and the first and second reflection electrodes RE1 and RE2 are formed at both end portions of the transparent electrode TE. Thereby, the first pixel area P1 is divided into a transmission area including the transparent electrode TE, and first and second reflection areas including the first and second reflection electrodes RE1 and RE2.

In the same way as the first pixel area mentioned above, each of the second, third and forth pixel areas P2, P3 and P4 are divided into a transmission area and first and second reflection areas.

Each of the first, second, third and forth pixel areas P1, P2, P3 and P4 includes the first and second reflection electrodes extended to the first and the second stepped portions. The stepped portions are the boundary between the transmission area, and the first and second reflection areas. Thereby, light leaking caused by the abnormal arrangement of the liquid crystal molecules is prevented. A cross-sectional view of unit pixel areas of the display substrate in FIG. 5, are substantially identified to the cross-sectional view of FIGS. 2 and 3, and any further discussion of the unit pixel areas of the display substrate is omitted for brevity.

As mentioned above in accordance with the present invention, a transmission area is defined at the center of a unit pixel area in a transflective display substrate, and first and second reflection areas are defined at both end portions of the transmission area thereby, preventing light from leaking at the stepped portion corresponding to the boundary between the transmission area and the reflection area caused by the rubbing process used for aligning liquid crystal molecules.

Each pixel area is divided into a first reflection area, a transmission area and a second reflection area so that the aperture ratio of the unit pixel area is not decreased although light leaking is prevented.

What has been described is deemed to be illustrative of the principles of the invention. Further and other modification of the embodiments will be apparent to those skilled in the art and may be made without, however, departing from the spirit and scope of the invention.

What is claimed is:

1. A display substrate comprising:
a plurality of source wirings extended in a first direction;
a plurality of gate wirings extended in a second direction crossing the first direction;
a plurality of pixel areas defined by the source wirings and the gate wirings; and
a plurality of pixel electrodes formed in the pixel areas, each of the pixel electrodes including first and second reflection electrodes formed at end portions of each of the pixel areas defining first and second reflection areas, and a transparent electrode formed between the first and second reflection electrodes defining a transmission area.

2. The display substrate of claim 1, wherein the pixel areas comprise:
a first pixel area including a first switching device electrically connected to an Mth source wiring and an (N−1)th gate wiring, and a first pixel electrode connected to the first switching device; and
a second pixel area including a second switching device electrically connected to the Mth source wiring and Nth gate wiring, and a second pixel electrode electrically connected to the second switching device,
where M and N are natural numbers.

3. The display substrate of claim 2, wherein the first switching device is formed in the first reflection area, and the second switching device is formed in the second reflection area.

4. The display substrate of claim 3, wherein the first and second pixel areas further comprise first and second storage electrodes, and wherein
the first and second storage electrodes are formed adjacent to the first and second switching devices, respectively.

5. The display substrate of claim 2, further comprising:
an organic insulation layer formed in the first and second reflection areas;
a first stepped portion formed at a first boundary between the transmission area and the first reflection area; and
a second stepped portion formed at a second boundary between the transmission area and the second reflection area.

6. The display substrate of claim 5, wherein the first reflection electrode is extended to cover the first stepped portion and the second reflection electrode is extended to cover the second stepped portion.

7. A display substrate comprising:
source wirings extended in a first direction;
gate wirings extended in a second direction crossing the first direction;
a first pixel area including a first switching device electrically connected to an Mth source wiring and an (N−1)th gate wiring and a first pixel electrode electrically connected to the first switching device; and
a second pixel area including a second switching device electrically connected to the Mth source wiring and the Nth gate wiring and a second pixel electrode electrically connected to the second switching device,
wherein each of the first and second pixel areas are divided into a transmission area to transmit light, and first and second reflection areas at end portions of the transmission area along the first direction to reflect light, where N and M are natural numbers.

8. The display substrate of claim 7, further comprising:
a transparent electrode formed in the transmission area;
a first reflection electrode formed in the first reflection area;
a second reflection electrode formed in the second reflection area; and
an organic insulation layer formed under the first and second reflection electrodes in the first and second reflection areas.

9. The display substrate of claim 8, wherein the first reflection electrode is extended to cover a first stepped portion formed at a first boundary between the transmission area and the first reflection area,
and the second reflection electrode is extended to cover a second stepped portion formed at a second boundary between the transmission area and the second reflection area.

10. A method of manufacturing a display substrate comprising:
forming a switching device in a pixel area defined by gate wirings and source wirings crossing each other;
forming an organic insulation layer on the pixel area including the switching device;
forming a first organic insulation pattern and a second organic insulation pattern at end portions of the pixel area, respectively, to divide the pixel area into a first reflection area, a transmission area and a second reflection area;
forming a transparent electrode electrically connected to the switching device in the transmission area; and
forming first and second reflection electrodes on the first and second organic insulation patterns.

11. The method of claim 10, wherein one of the first and second organic insulation patterns is formed on the switching device.

12. The method of claim 10, wherein the first reflection electrode is extended to a first boundary between the first reflection area and the transmission area.

13. The method of claim 10, wherein the second reflection electrode is extended to a second boundary between the second reflection area and the transmission area.

14. A display panel comprising:
an array substrate including;
a plurality of pixel areas defined by source wirings and gate wirings; and
a plurality of pixel electrodes that are respectively formed in the pixel areas, each of the pixel electrodes including first and second reflection electrodes defining first and second reflection areas, and a transparent electrode formed between the first and second reflection electrodes to define a transmission area; and
an opposite substrate combined with the array substrate to receive a liquid crystal layer.

15. The display panel of claim 14, wherein the transmission area of each of the pixel areas is defined at a center of the pixel area in an extended direction of the gate wirings,
and the first and second reflection areas of each of the pixel areas are defined at both end portions of the transmission area, respectively.

16. The display panel of claim 15, further comprising:
an organic insulation layer formed in the first and second reflection areas;
a first stepped portion formed at a first boundary between the transmission area and the first reflection area; and
a second stepped portion formed at a second boundary between the transmission area and the second reflection area.

17. The display panel of claim 16, wherein the first reflection electrode is extended to cover the first stepped portion, and the second reflection electrode is extended to cover the second stepped portion.

18. The display panel of claim 14, wherein the opposite substrate further comprises
color filter patterns corresponding to the pixel areas, respectively, each of the color filter patterns having an opening corresponding to the first and second reflection areas.

19. The display panel of claim 14, wherein the liquid crystal layer is rubbed in an extended direction of the gate wirings.
